(19) United States
(12) Patent Application Publication
(10) Pub. No.: US 2009/0012750 A1
(43) Pub. Date: Jan. 8, 2009

(54) CHASSIS SURFACE TEMPERATURE ESTIMATE APPARATUS, METHOD, PROGRAM, AND STORAGE MEDIUM

(76) Inventors: Yutaka Kumano, Hyogo (JP); Tetsuyoshi Ogura, Osaka (JP); Toru Yamada, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/161,946

(22) PCT Filed: Jan. 9, 2007
(86) PCT No.: PCT/JP2007/050073

§ 371 Date: Jul. 23, 2008

(30) Foreign Application Priority Data
Jan. 23, 2006 (JP) 2006-013967

(51) Int. Cl. G06F 17/50; G06F 17/10

(52) U.S. Cl. 703/1; 703/2

(57) ABSTRACT

A chassis surface temperature estimate apparatus capable of quickly and easily estimating a chassis surface temperature without obtaining a parameter for each component through actual measurement for thermal design is provided. A thermal analysis execution section (6) executes a thermal analysis in units of heat-generation groups each including at least one heat-generating component, and obtains the chassis surface temperatures caused by respective heat-generation groups. A storage section (8) stores the chassis surface temperatures obtained for respective heat-generation group. A synthesis section (7) firstly reads the chassis surface temperature data from the storage section (8), and converts the chassis surface temperatures caused by respective heat-generation groups to radiation amounts. Secondly, the synthesis section (7) calculates a sum of radiation amounts by adding the radiation amounts obtained through the conversion. The synthesis section (7) calculates the chassis surface temperature in which the chassis surface temperatures of respective heat-generation groups are combined with each other by converting the obtained sum of the radiation amounts to a temperature.

### TECHNICAL FIELD

The present invention relates to a chassis surface temperature estimate apparatus, method, program, and a storage medium. More particularly, the present invention relates to a chassis surface temperature estimate apparatus, method, program, and a storage medium, which are used for estimating a surface temperature of a chassis when components are laid out inside the chassis of an electronic apparatus.

### BACKGROUND ART

In recent years, as a function of a compact electronic apparatus typified by a mobile telephone is enhanced, total power consumption of components incorporated in a chassis of the electronic apparatus increases. The increase of total power consumption of the components leads to increase of a total amount of heat generated by the components, and therefore a chassis surface temperature of the electronic apparatus also continues to increase. Accordingly, thermal design performed when designing the electronic apparatus becomes extremely difficult, as compared to that performed in a conventional art.

In general, the thermal design is performed in combination with component layout design for laying out components to be incorporated in the electronic apparatus, in an early step of a design process for the electronic apparatus. The reason the thermal design is performed in combination with the components positioning design is as follows.

In the component layout design, subsequent to the determination of the layout of respective components, some steps such as wiring design for connecting the respective components with each other, and test production evaluation, are performed. If a problem associated with heat generation of the electronic apparatus arises in these subsequent steps, the layout of the respective components needs to be changed taking into consideration the amount of generated heat. Returning to the component layout design from the steps subsequent thereto in the design process leads to waste of time and cost in the design process for the electronic apparatus. Therefore, when the layout of the respective components is determined in the component lay out design, it is necessary to simultaneously obtain thermal behavior of each component by concurrently performing the thermal design.

Patent Document 1 discloses an exemplary apparatus for obtaining thermal behaviors of components during the component layout design.

FIG. 6 is a functional block diagram schematically illustrating a structure of a conventional component placing apparatus disclosed in Patent Document 1.

The component placing apparatus shown in FIG. 6 includes: thermal constraint input means 101 for receiving an allowable temperature; a memory 102; unplaced component group 104 for recording unplaced components; unplaced component extraction means 103 for extracting the unplaced component from the unplaced component group 104; component provisionally-placing means 105 for provisionally placing the component extracted by the unplaced component extraction means 103; temperature calculation means 106 for calculating an ambient temperature of the component having been provisionally placed by the component provisionally-placing means 105; placing determination means 107 for determining that the provisional position is valid when the maximum temperature calculated by the temperature calculation means 106 is lower than the allowable temperature; component unplacing means 108 for canceling the provisional position when the maximum temperature calculated by the temperature calculation means 106 is higher than the allowable temperature; and control means 109 for making determination for a series of process steps.

FIG. 7 is a diagram for explaining an operation performed by the temperature calculation means shown in FIG. 6.

As shown in FIG. 7, two components 121a and 121b are indicated by dashed lines. Each of the components 121a and 121b have a rectangular contour. The components 121a and 121b are spaced at an interval which is equal to or greater than a predetermined allowable interval.

Further, ranges influenced by heat of a component A are shown by an area 122a, an area 123a, and an area 124a, each having an octagonal contour, in ascending order of the area size. Similarly, ranges influenced by heat of a component B are shown by an area 122b, an area 123b, and an area 124b, each having an octagonal contour, in ascending order of the area size.

Each octagonal contour indicating the range influenced by heat has a weighting value that is inversely proportional to the area size thereof. A weighting value of a portion on which the octagonal areas overlap each other is able to be obtained by adding weighting values of respective figures overlapping each other.

The weighting value of the area 123a is represented as W123a, the weighing value of the area 124a is represented as W124a, the weighting value of the area 123b is represented as W123b, and the weighting value of the area 124b is represented as W124b. In this case, a weighting value W of an area indicated by hatching in FIG. 7, that is, an area on which the areas 123a, 124a, 123b, and 124b overlap each other, is obtained as W123a+W124a+W123b+W124b.

The contour of the component, the areas representing the ranges influenced by heat of the component, and the weighting values associated with the areas are previously registered for each component to be placed.

The temperature calculation means 106 calculates an ambient temperature T of a component based on the weighting value W by using the following equation (1).

T=α×W+β (1)

Here, the proportionality constant α represents a value which is appropriately obtained for each component through actual measurement, and β represents an environmental temperature obtained before electricity is conducted.

### Patent Document 1: Japanese Laid-Open Patent Publication No. 5-327296

### DISCLOSURE OF THE INVENTION

### Problems to be Solved by the Invention

The conventional component placing apparatus as described above performs thermal analysis each time one component is provisionally positioned, thereby obtaining an ambient temperature of the provisionally placed component. The component placing apparatus changes the position of the provisionally placed component when the obtained ambient temperature of the component is higher than the allowable temperature, where as the component placing apparatus determines the provisional position of the component as being definite when the obtained ambient temperature of the component is lower than the allowable temperature. In this manner, the conventional component placing apparatus performs thermal analysis each time one component is positioned, so as to sequentially position all the components.

However, the conventional component placing process includes the following problems.

The temperature calculation means of the conventional component placing apparatus uses the weighting value W and the proportionality constant α so as to obtain the ambient temperature T of a component. The weighting value W and the proportionality constant α are defined for each component, and a database for storing the weighting values W and the proportionality constants α of all the components of the electronic apparatus is necessary.

In particular, the proportionality constant α represents a parameter obtained for each component through measurement, and therefore a lot of time needs to be consumed for obtaining the parameter for all heat-generating components of the electronic apparatus.

Further, each time variety of components available for the electronic apparatus is increased, it is necessary to obtain parameters of some components through measurement and to update the database for storing the parameter of each component.

To solve the aforementioned problems, an object of the present invention is to provide a chassis surface temperature estimate apparatus, a chassis surface temperature estimate method, and a chassis surface temperature estimate program each capable of quickly and easily estimating a chassis surface temperature in the thermal design without obtaining a parameter of each component through actual measurement, as well as a computer-readable storage medium having the program stored therein.

### Solution to the Problems

A first aspect is directed to a chassis surface temperature estimate apparatus for estimating a chassis surface temperature of an electronic apparatus having a chassis and at least one heat-generating component incorporated in the chassis. The chassis surface temperature estimate apparatus includes: a thermal analysis execution section for executing a thermal analysis in units of heat-generation groups each including at least one heat-generating component, obtaining the chassis surface temperatures caused by respective heat-generation groups, and generating chassis surface temperature data including the chassis surface temperatures caused by respective heat-generation groups; a storage section for storing the chassis surface temperature data; and a synthesis section for reading the chassis surface temperature data from the storage section, converting the chassis surface temperatures caused by respective heat-generating components to radiation amounts, calculating a sum of the radiation amounts, and thereafter converting the sum of the radiation amounts to a temperature.

According to the configuration, the synthesis section calculates the chassis surface temperature by converting the chassis surface temperature data of respective heat-generation groups to radiation amounts, adding the radiation amounts, and thereafter converting a sum of the radiation amounts having been obtained to a temperature. Accordingly, it is possible to quickly and easily estimate the chassis surface temperature without using a constant for calculating a temperature, which was obtained through a measurement in the conventional art.

In this case, a geometry data input section for receiving geometry data in which at least position and dimensions are defined for a plurality of components included in the electronic apparatus; an attribute data input section for receiving attribute data in which at least an amount of heat generated by each of the components is defined; a heat-generating component selection section for selecting the heat-generating components from among the components in accordance with the amount of generated heat defined by the attribute data; and a heat-generating component sorting section for sorting the selected heat-generating components into the heat-generation groups, may be further provided. The thermal analysis execution section may execute the thermal analysis based on the geometry data and the attribute data.

According to the configuration, the thermal analysis execution section is allowed to use the geometry data and the attribute data of each component, and therefore it is possible to efficiently execute the thermal analysis by using the geometry data and the attribute data.

Further, the thermal analysis execution section may create at least one of a function expressing the chassis surface temperature by a parameter representing a relative position of a heat-generation group to the chassis, and a function expressing the chassis surface temperature by a parameter representing an amount of heat generated by a heat-generation group.

According to the configuration, even when the position of the component or the amount of heat generated by the component is changed, it is possible to quickly estimate the chassis surface temperature by re-using the function having been previously created.

A second aspect is directed to a chassis surface temperature estimate program for estimating a chassis surface temperature of an electronic apparatus having a chassis and at least one heat-generating component incorporated in the chassis. The program causes a computer to execute: a thermal analysis execution function of executing a thermal analysis in units of heat-generation groups each including at least one heat-generating component, obtaining the chassis surface temperatures caused by respective heat-generation groups, and generating chassis surface temperature data including the chassis surface temperatures caused by respective heat-generation groups; a storage function of storing the chassis surface temperature data; and a synthesis function of reading the chassis surface temperature data from a storage section, converting the chassis surface temperatures caused by respective heat-generating components to radiation amounts, calculating a sum of the radiation amount, and thereafter converting the sum of the radiation amounts to a temperature.

According to the configuration, the chassis surface temperature is calculated by converting the chassis surface temperature data of respective heat-generation groups radiation amounts, adding the radiation amounts, and thereafter converting a sum of the radiation amounts having been obtained to a temperature s. Accordingly, it is possible to quickly and easily estimate the chassis surface temperature without using a constant, for calculating a temperature, which was obtained through a conventional measurement in the conventional art.

In this case, the chassis temperature estimate program may cause the computer to further execute: a geometry data input function of receiving geometry data in which at least position and dimensions are defined for a plurality of components included in the electronic apparatus; an attribute data input function of receiving attribute data in which at least an amount of heat generated by each of the components is defined; a heat-generating component selection function of selecting the heat-generating components from among the components in accordance with the amount of generated heat defined by the attribute data; and a heat-generating component sorting function of sorting the selected heat-generating components into the heat-generation groups. In the thermal analysis execution function, the thermal analysis may be executed based on the geometry data and the attribute data.

According to the configuration, the geometry data and the attribute data of each component can be used, whereby it is possible to efficiently execute the thermal analysis by using the geometry data and the attribute data.

Further, in the thermal analysis execution function, at least one of a function expressing the chassis surface temperature by a parameter representing a relative position of a heat-generation group to the chassis, and a function expressing the chassis surface temperature by a parameter representing an amount of heat generated by a heat-generation group.

According to the configuration, even when the position of the component or the amount of heat generated by the component is changed, it is possible to quickly estimate the chassis surface temperature by re-using the function having been previously created.

A third aspect is directed to a chassis surface temperature estimate method for estimating, by using a computer, a chassis surface temperature of an electronic apparatus having a chassis and at least one heat-generating component incorporated in the chassis. The method comprises: a thermal analysis execution step of causing the computer to execute a thermal analysis in units of heat-generation groups each including at least one heat-generating component, obtain the chassis surface temperatures caused by respective heat-generation groups, and generate chassis surface temperature data including the chassis surface temperatures caused by respective heat-generation groups; a storage step of causing the computer to store the chassis surface temperature data; and a synthesis step of causing the computer to read the stored chassis surface temperature data, convert the chassis surface temperatures caused by respective heat-generating components to radiation amounts, calculate a sum of the radiation amounts, and thereafter convert the sum of the radiation amounts to a temperature.

According to the configuration, the computer calculates the chassis surface temperature by converting the chassis surface temperature data of respective heat-generation groups to radiation amounts, adding the radiation amounts, and thereafter converting a sum of the radiation amounts having been obtained to a temperature. Accordingly, it is possible to quickly and easily estimate the chassis surface temperature without using a constant, for calculating a temperature, which was obtained through a conventional measurement in the conventional art.

In this case, a geometry data input step of causing the computer to receive geometry-data in which at least position and dimensions are defined for a plurality of components included in the electronic apparatus; an attribute data input step of causing the computer to receive attribute data in which at least an amount of heat generated by each of the components is defined; a heat-generating component selection step of causing the computer to select the heat-generating components from among the components in accordance with the amount of generated heat defined by the attribute data, and a heat-generating component sorting step of causing the computer to sort the selected heat-generating components into the heat-generation groups, may be further provided. In the thermal analysis execution step, the computer may be caused to execute the thermal analysis by using the geometry data and the attribute data.

According to the configuration, the geometry data and the attribute data of each component can be used, whereby it is possible to efficiently execute the thermal analysis by using the geometry data and the attribute data.

Further, in the thermal analysis execution step, the computer may be caused to generate at least one of a function expressing the chassis surface temperature by a parameter representing a relative position of a heat-generation group to the chassis, and a function expressing the chassis surface temperature by a parameter representing an amount of generated heat of a heat-generation group.

According to the configuration, even when the position of the component or the amount of heat generated by the component is changed, it is possible to quickly estimate the chassis surface temperature by re-using the function having been previously created.

A fourth aspect is directed to a computer-readable storage medium having stored therein a chassis temperature estimate program for estimating a chassis surface temperature of an electronic apparatus having a chassis and at least one heat-generating component incorporated in the chassis. The storage medium stores the chassis temperature estimate program for causing a computer to execute: a thermal analysis execution function of executing a thermal analysis in units of heat-generation groups each including at least one heat-generating component, obtaining the chassis surface temperatures caused by respective heat-generation groups, and generating chassis surface temperature data including the chassis surface temperatures caused by respective heat-generation group; a storage function of storing the chassis surface temperature data; and a synthesis function of reading the chassis surface temperature data from a storage section, converting the chassis surface temperatures caused by respective heat-generating components to radiation amounts, calculating a sum of the radiation amounts, and thereafter converting the sum of the radiation amounts to a temperature.

According to the configuration, the computer calculates the chassis surface temperature by converting the chassis surface temperature data of respective heat-generation groups to radiation amounts, adding the radiation amounts, and thereafter converting a sum of the radiation amounts having been obtained to a temperature. Accordingly, it is possible to quickly and easily estimate the chassis surface temperature without using a constant for calculating a temperature, which was obtained through a measurement in the conventional art.

### EFFECT OF THE INVENTION

According to the present invention, it is unnecessary prepare a constant for calculating a temperature, which has been necessary for adding temperatures and has required a lot of time for preparation, when a chassis surface temperature of an electronic apparatus is estimated. Therefore it is possible to efficiently estimate the chassis surface temperature of an electronic apparatus.

### BRIEF DESCRIPTION OF THE DRAWINGS

FIG. 1 is a functional block diagram schematically illustrating a structure of a chassis surface temperature estimate apparatus according to a first embodiment of the present invention.

FIG. 2 is a flow chart illustrating a chassis surface temperature estimate method performed by the chassis surface temperature estimate apparatus shown in FIG. 1.

FIG. 3 is a diagram illustrating an amount of heat radiation from a chassis surface.

FIG. 4 is a plan view schematically illustrating an electronic apparatus.

FIG. 5 is a cross-sectional view along V-V lines shown in FIG. 4.

FIG. 6 is a functional block diagram schematically illustrating a structure of a conventional component positioning apparatus.

FIG. 7 is a diagram for explaining an operation performed by a temperature calculation means shown in FIG. 6.

### DESCRIPTION OF THE REFERENCE CHARACTERS

1 chassis temperature estimate apparatus
2 geometry data input section
3 attribute data input section,
4 heat-generating component selection section
5 heat-generating component sorting section
6 thermal analysis execution section
7 synthesis section
8 storage section
9 CAD system
10 geometry database
11 attribute database

### BEST MODE FOR CARRYING OUT THE INVENTION

### First Embodiment

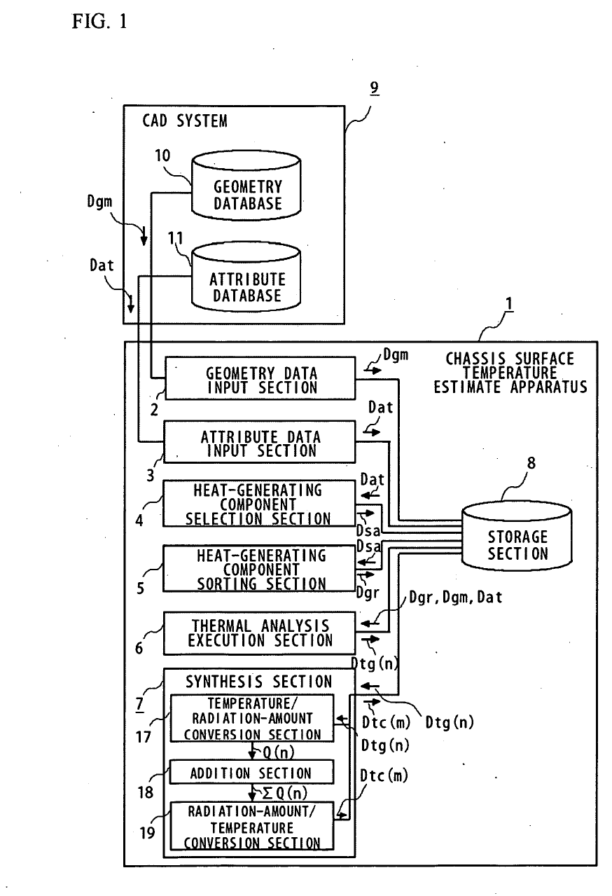

FIG. 1 is a functional block diagram schematically illustrating a structure of a chassis surface temperature estimate apparatus according to a first embodiment of the present invention.

A chassis surface temperature estimate apparatus 1 of the present embodiment is connected to a CAD system 9 used for designing an electronic apparatus.

Firstly, the CAD system 9 will be described. The CAD system 9 includes a geometry database 10 and an attribute database 11. The geometry database 10 and the attribute database 11 are each a database generated when an electronic apparatus is designed. More specifically, the geometry database 10 stores geometry data Dgm, which includes dimensions of a component and a position of the component relative to a chassis and which is settled when the electronic apparatus is designed. The attribute database 11 stores attribute data Dat representing a thermal conductivity, a specific heat, a density, an amount of generated heat, an initial temperature, a radiation rate, and the like of each component of the electronic apparatus.

Next, the chassis surface temperature estimate apparatus 1 includes: a geometry data input section 2; an attribute data input section 3; a heat-generating component selection section 4; a heat-generating component sorting section 5; a thermal analysis execution section 6; a synthesis section 7; and a storage section 8.

The geometry data input section 2 receives the geometry data Dgm in which the position, the dimensions, the material constant, and the like of each component of the electronic apparatus are defined, and stores the received geometry data Dgm in the storage section 8. The position of each component may be, for example, a relative position of each component with respect to the chassis represented by using a coordinate system. In the present embodiment, the geometry data input section 2 is capable of reading the geometry data Dgm from the geometry database 10 in the CAD system 9. The geometry database 10 may read a file in which the geometry data Dgm is stored, or may receive contour data and the like inputted by a designer using an input device such as a keyboard or a mouse, for example.

The attribute data input section 3 receives the attribute data Dat including a thermal conductivity, a specific heat, a density, an amount of generated heat, an initial temperature, a radiation rate, and the like of each component of the electronic apparatus, and stores the received attribute data Dat in the storage section 8. In the present embodiment, the attribute data input section 3 is capable of reading the attribute data Dat of each component from the attribute database 11 in the CAD system 9. The attribute data input section 3 may read a file in which the attribute data Dat is stored, or may receive data and the like inputted by a designer using an input device such as a keyboard or a mouse, for example.

The heat-generating component selection section 4 selects a plurality of heat-generating components from among the components based on an amount of generated heat which is defined by the attribute data Dat stored in the storage section 8. The heat-generating component selection section 4 stores, in the storage section 8, data Dsa representing the selected heat-generating components. The criterion used for selecting the heat-generating components by the heat-generating component selection section 4 may be defined by the attributed at a Dat acquired from the attribute database 11 of the CAD system 9 or may be designated by a designer using an input device such as a keyboard or a mouse of a PC or the like.

The heat-generating component sorting section 5 reads data Dsa representing the selected heat-generating components from the storage section 8, and sorts the heat-generating components having been selected by the heat-generating component selection section 4 into a plurality of heat-generation groups. The heat-generation group refers to a group of components including at least one heat-generating component. In the component layout design, the components may be sorted into, for example, a power supply component group, an image processing component group, a communication component group, and the like, based on a function and/or a position of respective components. It is advantageous to handle each component having been sorted based on the function, the position, and/or the like as a heat generation group, since thermal design can be efficiently performed. The heat-generating component sorting section 5 stores data Dgr, representing the heat-generation groups and the heat-generating components belonging to respective heat-generation groups, into the storage section 8. The criterion used for sorting the heat-generating components into groups by the heat-generating component sorting section 5 may be defined in the attribute database 11 of the CAD system 9, or may be designated by a designer using an input device such as a keyboard or a mouse of a PC or the like.

The thermal analysis execution section 6 reads, from the storage section 8, the data Dcr representing the heat generating groups and the heat-generating components belonging to respective heat-generating groups, the geometry data Dgm, and the attribute data Dat, and make models of all the heat-generating components included in heat-generation groups and non-heat-generating components including at least a chassis, based on the geometry data Dgm and the attributed at a Dat. The thermal analysis execution section 6 sequentially performs thermal analysis for each model having been made to calculate a chassis surface temperature for each heat-generation group. The thermal analysis execution section 6 generates chassis surface temperature data Dtg(n) including the calculated chassis surface temperature, and stores the chassis surface temperature data Dtg (n) in the storage section 8. The thermal analysis execution section 6 may be incorporated in the chassis surface temperature estimate apparatus 1 as in the present embodiment, or may be a device independent from the chassis surface temperature estimate apparatus 1.

The thermal analysis execution section 6 may perform the thermal analysis for a certain heat-generation group and generate at least one of a function expressing the chassis surface temperature by a parameter representing a relative position of the certain heat-generation group to the chassis, and a function expressing the chassis surface temperature by a parameter representing an amount of heat generated by the certain heat generation group.

For example, a relative position of a heat-generation group to the chassis may be represented in a coordinate system whose originating point is corresponding to a certain point. In a case where a function using a coordinate position of a heat-generation group as a parameter is prepared for calculating a chassis surface temperature caused by a heat-generation group, when position of the heat-generation group is changed, the chassis surface temperatures of the heat-generation group can be quickly re-calculated by designing coordinates of the heat generation group, based on results of the thermal analysis having been already performed. On the other hand, in a case where a function using the amount of heat generated by a heat-generation group as a parameter is prepared for calculating a case surface temperature caused by the heat-generation group, when the amount of heat generated by the heat-generation group is changed, the chassis surface temperature generated by the heat-generation group can be quickly re-calculated by using the prepared function.

The synthesis section 7 reads the chassis surface temperature data Dtg (n) from the storage section 8, and estimates a chassis surface temperature by using the chassis surface temperature of each group included in the read chassis surface temperature data Dtg(n). More specifically, the synthesis section 7 includes a temperature/radiation-amount conversion section 17, an addition section 18, and a radiation-amount/temperature conversion section 19. Firstly, the temperature/radiation-amount conversion section 17 converts the chassis surface temperatures caused by respective heat-generation groups, which are read from the storage section 8, into radiation amounts Q(n). Next, the addition section 18 adds the radiation amounts Q(n) obtained through the conversion to obtain a sum ΣQ(n) of the radiation amounts. The radiation-amount/temperature conversion section 19 converts the calculated sum ΣQ(n) of the radiation amounts having been obtained into a temperature, thereby obtaining the chassis surface temperature synthesized from the chassis surface temperatures caused by respective heat generation groups. The synthesis section 7 stores the chassis surface temperature data Dtc (m) calculated by the radiation-amount/temperature conversion section 19 into the storage section 8.

The chassis surface temperature estimate apparatus 1 may be configured as a dedicated apparatus, or may be configured as, for example, a computer system operating on a general-purpose apparatus (herein after, referred to as a PC or the like) such as a personal computer or a workstation. Functions of the geometry data input section 2, the attribute data input section 3, the heat-generating component selection section 4, the heat-generating component sorting section 5, the thermal analysis execution section 6, and the synthesis section 7 may be realized by the CPU of a PC or the like executing a predetermined program. As the storage section 8, not only a storage medium such as a hard disk and a RAM included in the PC or the like but also a portable storage medium such as a flexible disk, a memory card, or the like, a storage medium in a storage device on a network, or the like may be used.

Further, a program for causing a computer to execute processing performed by the geometry data input section 2, the attribute data input section 3, the heat-generating component selection section 4, the heat-generating component sorting section 5, the thermal analysis execution section 6, and the synthesis section 7 may be installed in a PC or the like, for example, from a storage medium such as a CD-ROM, or by download through a communication line, thereby configuring the chassis surface temperature estimate apparatus 1.

The hardware configuration is not limited to that shown in FIG. 1. For example, the functions of the chassis surface temperature estimate apparatus 1 may be divided such that the divided functions may be executed by a plurality of PCs or the like which are connected to the Internet, a LAN, or the like so as to communicate with each other.

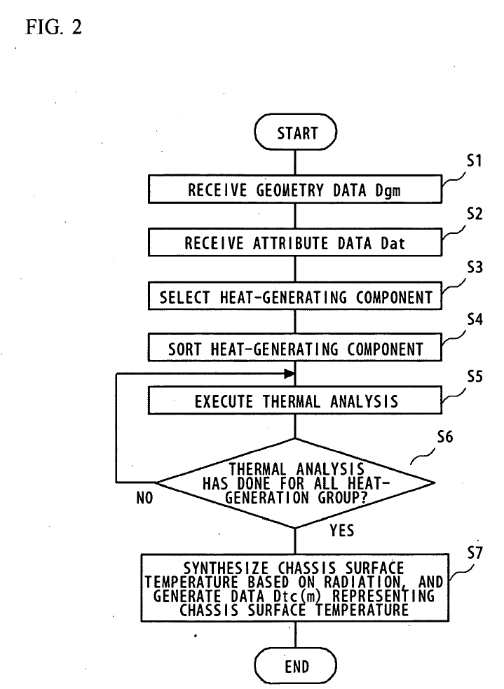

FIG. 2 is a flow chart illustrating a chassis surface temperature estimate method performed by the chassis surface temperature estimate apparatus shown in FIG. 1.

Firstly, the geometry data input section 2 receives the geometry data Dgm including the size and the position of each component of the electronic apparatus, and stores the received geometry data Dgm in the storage section 8 (step S1).

Next, the attribute data input section 3 receives the attribute data Dat including a thermal conductivity, a specific heat, a density, an amount of generated heat, an initial temperature, and a proportion of radiation of each component of the electronic apparatus, and stores the received attribute data Dat in the storage section 8 (step S2).

Next, the heat-generating component selection section 4 selects, from the storage section 8, the entire or a portion of the heat-generating components, to which an amount of heat is given, and stores the selected heat-generating components in the storage section 8 (step S3).

Next, the heat-generating component sorting section 5 sorts the heat-generating components selected by the heat-generating component selection section into a plurality of heat-generation groups, and stores data representing the sorted heat-generation groups into the storage section 8 (step S4).

Next, the thermal analysis execution section 6 performs thermal analysis for each heat-generation group, and calculates the chassis surface temperature caused by each heat-generation group (step S5). The thermal analysis execution section 6 determines whether or not the thermal analysis has been performed for all the heat-generation groups (step S6). The thermal analysis execution section 6 returns the process to step S5 when determining that the thermal analysis has not been performed for all the heat-generation groups (No in step S6), where as the thermal analysis execution section 6 advances the process to the following step S7 when determining that the thermal analysis has been performed for all the heat-generation groups.

The synthesis section 7 reads the chassis surface temperature data of the respective heat-generation groups, which a restored in the storage section 8, and combines the chassis surface temperatures caused by the respective heat-generation groups based on the radiation (step S7).

More specifically, the synthesis section 7 converts the chassis surface temperature caused by each heat-generation group to a radiation amount Q by using the following equation (2).

Q=ε₁×ε₂×σ×A×(T₁⁴−T₂⁴) (2)

Here, ε₁ represents an emissivity coefficient which represents a proportion of radiation between two surfaces where a heat is transferred, ε₂ represents a view factor which represents a proportion of radiation depending on shape between the two surfaces, and a relative position there between, a represents a Stefan-Boltzmann constant, A represents an area size of a micro area on a chassis surface, T₁ represents an absolute temperature of the micro area on the chassis surface, and T₂ represents an absolute temperature of a surface to which the heat is radiated. Further, the synthesis section 7 converts, to a temperature, a sum of the radiation amounts of the respective heat-generation groups, which are obtained through the conversion, by using the following equation (3).

T₁=(ΣQ/(ε₁×ε₂×σ×A)+T₂⁴)^{0.25} (3)

Here, ΣQ represents a sum of the radiation amounts of a micro area on the chassis surface.

The reason the synthesis section 7 is operable to estimate the chassis surface temperature by calculating the sum ΣQ of the radiation amounts and then converting the sum ΣQ of the radiation amounts to a temperature will be described.

As indicated by the above equation (2), the radiation amount is proportional to the fourth power of temperature. In general, when the radiation amounts each of which is proportional to the fourth power of temperature are added, it is expected that an error may be increased, whereby the temperature to which the sum of the radiation amounts is converted may be different from an actual chassis surface temperature.

However, although it is certain that a value of the radiation amount calculated for an electronic apparatus used at a room temperature (used under temperature range from about 25 to 40 degrees centigrade) is proportional to the fourth power of temperature, the coefficient is substantially small, so that the value actually represents a liner characteristic. The reason is as follows.

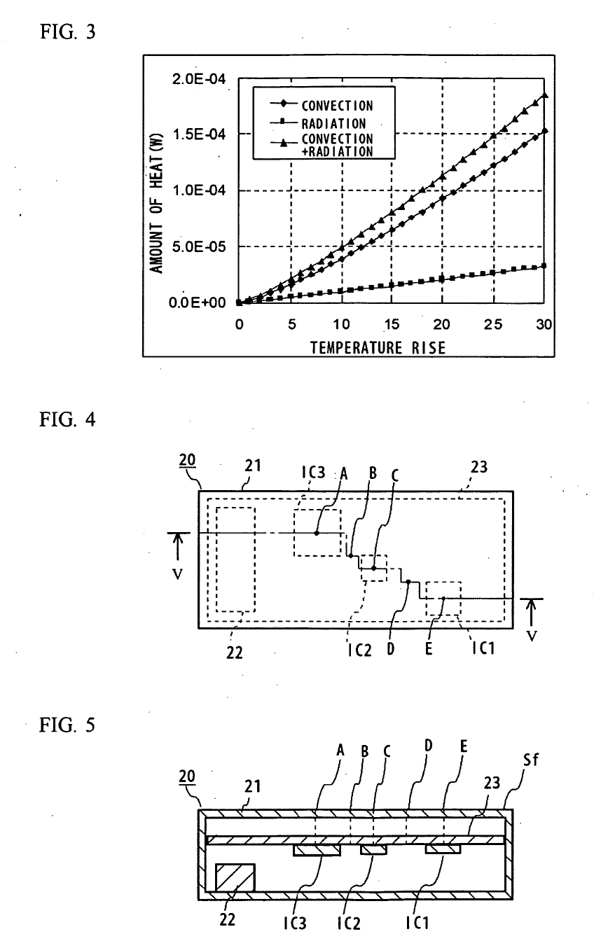

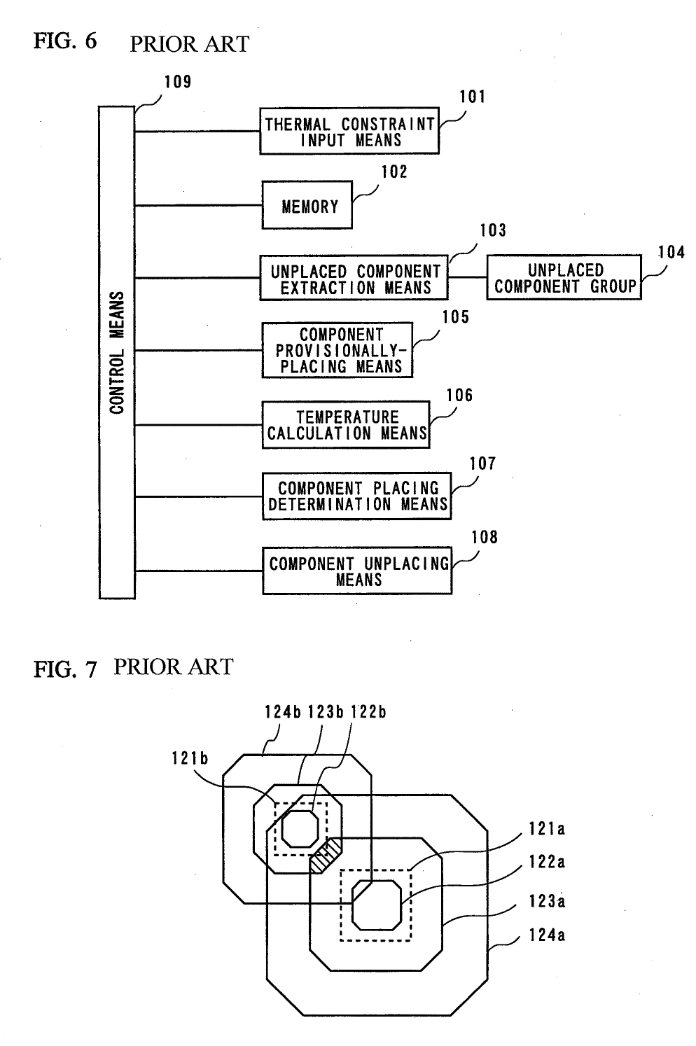

FIG. 3 is a diagram illustrating an amount of heat radiation from the chassis surface. In FIG. 3, an amount of radiation heat from an area of 0.5 mm×0.5 mm on the chassis surface, an amount of convection heat therefrom, and a sum of the amount of radiation heat and the amount of convection heat are each plotted against the rise in temperature of the chassis surface.

The amount of convection heat is proportional to the 1.25th power of temperature, and therefore the amount of convection heat represents a curve which is convex downward, as shown in FIG. 3. Further, the sum of the amount of convection heat and the amount of radiation heat also represents a curve which is convex downward.

On the other hand, the amount of radiation heat represents a linear characteristic when the rise in temperature of the chassis surface is equal to or less than 30 degrees centigrade. Therefore, in the case where the electronic apparatus is used at a room temperature and the rise in temperature of the chassis surface is within a range of 0 to 30 degrees centigrade, the amount of radiation heat can be approximated by a value proportional to the rise in temperature. Therefore, when both the temperature at which the electronic apparatus is used, and the rise in temperature of the heat-generating component are included in a range from a room temperature to the room temperature+about 20 degrees centigrade, the amount of radiation heat can be handled as a value proportional to the rise in temperature, whereby the rise in temperature may be synthesized by adding the amounts of radiation heats.

Hereinafter, a specific example of the surface temperature estimate method according to the present invention will be described.

FIG. 4 is a plan view schematically illustrating an electronic apparatus, and FIG. 5 is a cross-sectional view along V-V lines shown in FIG. 4.

The electronic apparatus 20 includes a chassis 21, a battery 22 and a substrate 23 each positioned inside the chassis 21, and heat-generating components IC1 to IC3 mounted on one surface of the substrate 23. In an example shown in FIGS. 4 and 5, for simplifying the description, the three heat-generating components IC1 to IC3 belong to the heat-generation groups which are different from each other (that is, each heat-generation group includes one heat-generating component).

Here, it is assumed that the chassis surface temperatures at five points A to E on a surface Sf of the chassis 21 are estimated. The point A, the point C, and the point E correspond to the center point of IC3, the center point of IC2, and the center point of IC, respectively. The point B is a point corresponding to a middle point between the bottom right corner of IC3 as shown in FIG. 4 and the top left corner of IC2 as shown in FIG. 4. The point D is a point corresponding to a middle point between the bottom right corner of IC2 as shown in FIG. 4 and the top left corner of IC1 as shown in FIG. 4.

TABLE 1

| | | | | | SUM OF TEMPERATURES | |
|---|---|---|---|---|---|---|
| | | | | | | CONVERTED |
| | | | | | CONVERTED | FROM |
| | ANALYSIS RESULT | | | | FROM | RADIATION |
| | IC1 ON | IC2 ON | IC3 ON | | CONVECTION | AMOUNTS |
| | (Dtg(1)) | (Dtg(2)) | (Dtg(3)) | ALL ON | AMOUNTS | (Dtc(m)) |
| POINT A | 6.2 | 3.0 | 12.5 | 20.4 | 18.1 | 20.5 |
| POINT B | 10.2 | 3.9 | 8.6 | 21.3 | 18.5 | 21.3 |
| POINT C | 13.8 | 4.9 | 6.2 | 23.4 | 20.5 | 23.3 |
| POINT D | 7.8 | 7.8 | 4.2 | 18.4 | 16.0 | 18.7 |
| POINT E | 4.8 | 14.2 | 3.0 | 20.6 | 18.6 | 20.9 |

Values in columns of “analysis result” shown in Table 1 indicate rises in temperatures at the points A to Eon the chassis surface Sf, which are analyzed in a conventional method. More specifically, values of column “IC1 ON”, column “IC2 ON”, and column “IC3 ON” represent rises in temperatures obtained when either one of IC1, IC2, and IC3 is powered on alone. Further, values in column “ALL ON” indicate the rises in temperature obtained when IC1 to IC3 are all powered on. Each value indicated in column “IC1 ON”, column “IC2 ON”, and column “IC3 ON” represents the chassis surface temperature Dtg(n) obtained for each heat-generation group.

On the other hand, values in columns of “sum of temperatures” shown in Table 1 indicate a sum of the rises in temperatures caused by IC1 to IC3 calculated in various methods. More specifically, values indicated in column “converted from convection amounts” represent temperatures calculated by converting the respective rises in temperature, which are obtained by turning on each of IC1 to IC3, into convection amounts, calculating a sum of the convection amounts, and then converting the sum of the convection amounts to the temperature.

Values in column “converted from radiation amounts” represent temperatures obtained by the chassis surface temperature estimate method according to the present invention. Specifically, values indicated in column “converted from radiation amounts” represent temperatures calculated by converting the respective rises in temperature, which are obtained by turning on each of IC1 to IC3, into radiation amounts, calculating a sum of the radiation amounts, and then converting the sum of the convection amounts to the temperature. That is, each value indicated in column “converted from radiation amounts” corresponds to the chassis surface temperature Dtc (m) calculated by combining the chassis surface temperatures Dtg(1) to Dtg(3) of each heat-generation group.

As indicated in Table 1, the values of column “converted from convection amounts” are apparently different from the values of the conventional analysis result (in column “ALL ON”).

On the other hand, the sum of temperatures obtained by using the chassis surface temperature estimate method according to the present invention, that is, each value of column “converted from radiation amounts”, is almost the same as that represented by the conventional analysis result, whereby a preferable analysis result is obtained.

Conventionally, a database of proportionality constant α used in equation (1) was necessary for calculating the chassis surface temperature of an electronic apparatus. The proportionality constant α of equation (1) is a value obtained through measurement for each heat-generating component, and therefore a lot of time was necessary for building the database of the proportionality constant α.

On the other hand, according to the present invention, thermal analysis is performed for each heat-generation group or for each heat-generating component, and thereafter the chassis surface temperature can be quickly and easily estimated by using the chassis surface temperature caused by each heat-generation group or each heat-generating component. In particular, the present invention does not require a proportionality constant which is empirically obtained through measurement, so that the chassis temperature can be calculated in a reduced time period.

Further, when the component layout is designed, the positions of the components in the chassis is examined by increasing or reducing the size of the components on the CAD system. According to the present invention, it is possible to obtain the chassis surface temperature by performing addition or subtraction of the radiation amount while the components are being placed. Therefore, it is possible to drastically improve the efficiency of the thermal design performed concurrently with the component layout design.

In particular, the chassis surface temperature estimate apparatus and method according to the present invention are effective especially for thermal design of an electronic apparatus which is used in the temperature range of 25 to 40 degrees centigrade. For example, the chassis surface temperature estimate apparatus and method according to the present invention are applicable to the component layout design and the thermal design of a mobile device such as a mobile telephone and a PDA.

Although in the present embodiment the chassis surface temperature estimate apparatus is connected to the CAD system including the geometry database and the attribute database, the CAD system is not indispensable. The chassis surface temperature estimate apparatus may be configured so as to acquire, as a file or through an input from a user, data which is generated by the CAD system when an electronic apparatus is designed.

Further, although in the aforementioned embodiment the thermal analysis execution section performs the thermal analysis for each heat-generation group including at least one heat-generating component, one heat-generating component may be handled as one heat-generation group such that the thermal analysis can be performed for each heat-generating component. Also in this case, the chassis surface temperatures obtained for respective heat-generating components can be combined with each other, thereby exerting the same effect as described in the aforementioned embodiment.

Moreover, although in the aforementioned embodiment the chassis surface temperature estimate apparatus is connected to the CAD system, the chassis surface temperature estimate apparatus may not be necessarily connected to the CAD system. However, when the chassis surface temperature estimate apparatus operates in combination with the CAD system, it is possible to exert an advantageous effect in that the thermal design can be efficiently performed when the component layout is designed. Further, the chassis surface temperature estimate apparatus may be incorporated in the CAD system as a function thereof.

Further, in the aforementioned embodiment, the chassis surface temperature estimate apparatus may access the geometry database and the attribute database of the CAD system without storing, in the storage section, the geometry data and the attribute data read from the CAD system so as to use the same. Further, the chassis surface temperature estimate apparatus may include a geometry database for storing the CAD geometry data and an attribute database for storing the attribute data.

Further, the functional blocks (FIG. 1) of the chassis temperature estimate apparatus according to the aforementioned embodiment may be realized as an LSI, which is an integrated circuit. These functional blocks may be constructed in a chip form, or may be constructed in a chip form so as to include a part or all of the functional blocks. The LSI may be referred to as an IC, a system LSI, a super LSI, or an ultra LSI, depending on the degree of integration. Also, the method of integration is not limited to LSI, and may be realized by a dedicated circuit or a general purpose processor. Also, an FPGA (Field Programmable Gate Array), which can be programmed after LSI is manufactured, or a reconfigurable processor enabling connections and settings of the circuit cells in the LSI to be reconfigured may be used. Further, in the case where another integration technology replacing LSI becomes available due to improvement of a semiconductor technology or due to the emergence of another technology derived therefrom, integration of the functional blocks may be performed using such a technology. For example, biotechnology may be applied thereto.

### INDUSTRIAL APPLICABILITY

The present invention can be used as an apparatus, a method, and a program for estimating a chassis surface temperature of an electronic apparatus at the stage of component layout design of the electronic apparatus, and a storage medium for storing the program in a computer-readable form.

1. A chassis surface temperature estimate apparatus for estimating a chassis surface temperature of an electronic apparatus having a chassis and at least one heat-generating component incorporated in the chassis, the chassis surface temperature estimate apparatus comprising:
a thermal analysis execution section for executing a thermal analysis in units of heat-generation groups each including at least one heat-generating component, obtaining the chassis surface temperatures caused by respective heat-generation groups, and generating chassis surface temperature data including the chassis surface temperatures caused by respective heat-generation groups;
a storage section for storing the chassis surface temperature data; and
a synthesis section for reading the chassis surface temperature data from the storage section, converting the chassis surface temperatures caused by respective heat-generating components to radiation amounts, calculating a sum of the radiation amounts, and thereafter converting the sum of the radiation amounts to a temperature.

2. The chassis surface temperature estimate apparatus according to claim 1, further comprising:
a geometry data input section for receiving geometry data in which at least position and dimensions are defined for a plurality of components included in the electronic apparatus;
an attribute data input section for receiving attribute data in which at least an amount of heat generated by each of the components is defined;
a heat-generating component selection section for selecting the heat-generating components from among the components in accordance with the amount of generated heat defined by the attribute data; and
a heat-generating component sorting section for sorting the selected heat-generating components into the heat-generation groups,
wherein the thermal analysis execution section executes the thermal analysis based on the geometry data and the attribute data.

3. The chassis surface temperature estimate apparatus according to claim 1, wherein the thermal analysis execution section creates at least one of a function expressing the chassis surface temperature by a parameter representing a relative position of a heat-generation group to the chassis, and a function representing the chassis surface temperature by a parameter representing the amount of heat generated by a heat-generation group.

4. A chassis surface temperature estimate program for estimating a chassis surface temperature of an electronic apparatus having a chassis and at least one heat-generating component incorporated in the chassis, said program causing a computer to execute:
a thermal analysis execution function of executing a thermal analysis in units of heat-generation groups each including at least one heat-generating component, obtaining the chassis surface temperatures caused by respective heat-generation groups, and generating chassis surface temperature data including the chassis surface temperatures caused by respective heat-generation groups;
a storage function of storing the chassis surface temperature data; and
a synthesis function of reading the chassis surface temperature data, converting the chassis surface temperatures caused by respective heat-generating components to radiation amounts, calculating a sum of the radiation amounts, and thereafter converting the sum of the radiation amounts to a temperature.

5. The chassis surface temperature estimate program according to claim 4, said program causing the computer to further execute:
a geometry data input function of receiving geometry data in which at least position and dimensions are defined for a plurality of components included in the electronic apparatus;
an attribute data input function of receiving attribute data in which at least an amount of heat generated by each of the components is defined;
a heat-generating component selection function of selecting the heat-generating components from among the components in accordance with the amount of generated heat defined by the attribute data; and
a heat-generating component sorting function of sorting the selected heat-generating components into the heat-generation groups,
wherein in the thermal analysis execution function, the thermal analysis is executed based on the geometry data and the attribute data.

6. The chassis surface temperature estimate program according to claim 4, wherein in the thermal analysis execution function, at least one of a function expressing the chassis surface temperature by a parameter representing a relative position of a heat-generation group to the chassis, and a function expressing the chassis surface temperature by a parameter representing an amount of heat generated by a heat-generation group.

7. A chassis surface temperature estimate method for estimating, by using a computer, a chassis surface temperature of an electronic apparatus having a chassis and at least one heat-generating component incorporated in the chassis, the chassis surface temperature estimate method comprising:
a thermal analysis execution step of causing the computer to execute a thermal analysis in units of heat-generation groups each including at least one heat-generating component, obtain the chassis surface temperatures cause by respective heat-generation groups, and generate chassis surface temperature data including the chassis surface temperatures caused by respective heat-generation groups;
a storage step of causing the computer to store the chassis surface temperature data; and
a synthesis step of causing the computer to read the stored chassis surface temperature data, convert the chassis surface temperatures caused by respective heat-generating components to radiation amounts, and calculate a sum of the radiation amounts, and thereafter convert the sum of the radiation amounts to a temperature.

8. The chassis surface temperature estimate method according to claim 7, further comprising
a geometry data input step of causing the computer to receive geometry data in which at least position and dimensions are defined for a plurality of components included in the electronic apparatus,
an attribute data input step of causing the computer to receive attribute data in which at least an amount of heat generated by each of the components is defined,
a heat-generating component selection step of causing the computer to select the heat-generating components from among the components in accordance with the amount of generated heat defined by the attribute data, and
a heat-generating component sorting step of causing the computer to sort the selected heat-generating components into the heat-generation groups,
wherein in the thermal analysis execution step, the computer is caused to execute the thermal analysis based on the geometry data and the attribute data.

9. The chassis surface temperature estimate method according to claim 7, wherein in the thermal analysis execution step, the computer is caused to create at least one of a function expressing the chassis surface temperature by a parameter representing a relative position of a heat-generation group to the chassis, and a function expressing the chassis surface temperature by a parameter representing an amount of generated heat of a heat-generation group.

10. A computer-readable storage medium having stored therein a chassis temperature estimate program, used for estimating a chassis surface temperature of an electronic apparatus having a chassis and at least one heat-generating component incorporated in the chassis, said program causing a computer to execute:
a thermal analysis execution function of executing a thermal analysis in units of heat-generation groups each including at least one heat-generating component, obtaining the chassis surface temperatures caused by respective heat-generation groups, and generating chassis surface temperature data including the chassis surface temperatures caused by respective heat-generation groups;
a storage function of storing the chassis surface temperature data; and
a synthesis function of reading the chassis surface temperature data, converting the chassis surface temperatures caused by respective heat-generating components to radiation amounts, calculating a sum of the radiation amounts, and thereafter converting the sum of the radiation amounts to a temperature.
